(19) United States
(12) Patent Application Publication
(10) Pub. No.: US 2026/0065048 A1
(43) Pub. Date: Mar. 5, 2026

(54) SELF-SPECULATIVE DECODING USING FORECASTED EMBEDDINGS IN AUTOREGRESSIVE GENERATIVE ARTIFICIAL INTELLIGENCE MODELS

(71) Applicant: QUALCOMM Incorporated, San Diego, CA (US)

(72) Inventors: Mingu LEE, San Diego, CA (US); Raghavv GOEL, San Diego, CA (US); Wonseok JEON, San Diego, CA (US); Mukul GAGRANI, Milpitas, CA (US); Junyoung PARK, Palo Alto, CA (US); Christopher LOTT, San Diego, CA (US)

(21) Appl. No.: 18/985,889

(22) Filed: Dec. 18, 2024

Related U.S. Application Data
(60) Provisional application No. 63/690,749, filed on Sep. 4, 2024.

(51) Int. Cl. G06N 3/08; G06N 3/0475; G06N 3/063

(52) U.S. Cl. CPC G06N 3/08; G06N 3/0475; G06N 3/063

(57) ABSTRACT

Certain aspects of the present disclosure provide techniques and apparatus for generating a response to a query input in a generative artificial intelligence model. An example method generally includes receiving an input prompt for processing; generating a set of forecasted parameters for the input prompt using a parameter prediction model; generating, using a generative artificial intelligence model, a response to the input prompt based on the input prompt and the set of forecasted parameters; and outputting the generated response.

### CROSS-REFERENCE TO RELATED APPLICATIONS

This application claims priority to and benefit of U.S. Provisional Patent Application Ser. No. 63/690,749, entitled “Self-Speculative Decoding Using Forecasted Embeddings in Autoregressive Generative Artificial Intelligence Models,” filed Sep. 4, 2024, and assigned to the assignee hereof, the entire contents of which are hereby incorporated by reference.

### INTRODUCTION

Aspects of the present disclosure relate to generative artificial intelligence models, and more specifically to speculative decoding in generative artificial intelligence models (also referred to as “generative machine learning models” or “generative models”).

Generative artificial intelligence models can be used in various environments in order to generate a response to an input prompt (also referred to as a query or an input). For example, generative artificial intelligence models can be used in chatbot applications in which large language models (LLMs) are used to generate an answer, or at least a response, to an input prompt. Other examples in which generative artificial intelligence models can be used include a latent diffusion model, in which a model generates an image from an input text description of the content of the desired image, decision transformers, in which future actions are predicted based on sequences of prior actions within a given environment, or the like.

Generally, generating a response to a query using generative artificial intelligence models may be computationally expensive. For example, in a chatbot deployment in which a large language model is used to generate a response to a query formatted as a text query, a response to the query may be generated using a pass through the large language model for each token (e.g., a word or part of a word) generated as part of the response. The output of each pass may be a probability distribution on a set of tokens (e.g., words or parts of words) from which the next token (e.g., a word or part of a word) may be selected, for example, by sampling or based on maximum likelihood. Because a pass through a large language model is used to generate each word (or token(s)) in a response to a query, the computational expense may be modeled as the product of the number of words included in the response and the computational resource expense (e.g., in terms of processing power, memory bandwidth, and/or other compute resources used) of performing a pass through the large language model, which generally increases as the number of parameters within the large language model increases.

### BRIEF SUMMARY

Certain aspects of the present disclosure provide a method for generating a response to an input prompt using a generative artificial intelligence model. The method generally includes receiving a plurality of sets of tokens generated based on an input prompt and a first generative artificial intelligence model, each set of tokens in the plurality of sets of tokens corresponding to a candidate response to the input prompt; selecting, using a second generative artificial intelligence model and recursive adjustment of a target distribution associated with the received plurality of sets of tokens, a set of tokens from the plurality of sets of tokens; and outputting the selected set of tokens as a response to the input prompt.

Certain aspects of the present disclosure provide a method for generating a response to an input prompt using a generative artificial intelligence model. The method generally includes generating, based on an input prompt and a generative artificial intelligence model, a first plurality of sets of tokens, each set of tokens in the first plurality of sets of tokens corresponding to a first portion of a candidate response to the input prompt. Using the generative artificial intelligence model, a second plurality of sets of tokens are speculatively generated. Each set of tokens in the second plurality of sets of tokens generally corresponds to a second portion of the candidate response to the input prompt based on the first plurality of sets of tokens. While speculatively generating the second plurality of sets of tokens, a set of tokens from the first plurality of sets of tokens are selected, and the selected set of tokens from the first plurality of tokens and an associated set of tokens in the second plurality of tokens are output as a response to the input prompt.

Certain aspects of the present disclosure provide a method for efficiently generating a response to an input prompt using a generative artificial intelligence model. The method generally includes receiving an input prompt for processing; generating a set of forecasted parameters for the input prompt using a parameter prediction model; generating, using a generative artificial intelligence model, a response to the input prompt based on the input prompt and the set of forecasted parameters; and outputting the generated response.

Certain aspects of the present disclosure provide a method for training a model to generate parameters used by a generative artificial intelligence model to efficiently generate a response to an input prompt. The method generally includes training a self-speculative decoding prediction model to predict a set of parameters for speculatively processing an input query through a generative artificial intelligence model; and deploying the self-speculative decoding parameter prediction model.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict only certain aspects of this disclosure and are therefore not to be considered limiting of the scope of this disclosure.

FIG. 1 illustrates an example pipeline for self-speculative decoding in generative artificial intelligence models, according to certain aspects of the present disclosure.

FIG. 2 illustrates example architectures for self-speculative decoding in generative artificial intelligence models, according to certain aspects of the present disclosure.

FIG. 3 illustrates an example pipeline for efficient self-speculative decoding in generative artificial intelligence models based on forecasted embedding inputs, according to certain aspects of the present disclosure.

FIG. 4 illustrates an example of generating a response to an input prompt using self-speculative decoding based on forecasted embedding inputs, according to certain aspects of the present disclosure.

FIG. 5 illustrates an example of generating a response to a multimodal input prompt using self-speculative decoding based on forecasted embedding inputs, according to certain aspects of the present disclosure.

FIG. 6 illustrates an example pipeline for training a generative artificial intelligence model for self-speculative decoding based on forecasted embedding inputs, according to certain aspects of the present disclosure.

FIG. 7 illustrates an example of training a generative artificial intelligence model for self-speculative decoding for multimodal inputs, according to certain aspects of the present disclosure.

FIG. 8 illustrates example operations for efficient self-speculative decoding in generative artificial intelligence models based on forecasted embedding inputs, according to certain aspects of the present disclosure.

FIG. 9 illustrates example operations for training a generative artificial intelligence model for efficient self-speculative decoding based on forecasted embedding inputs, according to certain aspects of the present disclosure.

FIG. 10 depicts an example processing system configured to perform various aspects of the present disclosure.

FIG. 11 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatus, methods, processing systems, and computer-readable mediums for efficiently generating responses to input queries using generative artificial intelligence models.

Generally, generative artificial intelligence models generate a response to a query input into the model. For example, a large language model (LLM) deployed within a chatbot can generate a response to a query using multiple passes through the large language model, with each successive pass being based on the query (which may be tokenized for processing) and the tokens (or words) generated using previous passes through the large language model. Generally, these large language models may include a large number (e.g., billions or trillions) of weights or parameters within the model. Because of the size of these models and the operations performed on each token to predict what should be the next token generated in response to a query and the previously generated tokens, it may not be practical, or even possible, to deploy large language models on a variety of devices which have limited memory, storage, and/or processing capabilities relative to cloud compute instances on which large language models typically operate. Further, in some cases, the memory bandwidth involved in generating a response to a query provided as input into a model may prevent compute resources from being used for other tasks.

To improve the efficiency and throughput of large language models, speculative decoding techniques allow for a smaller language model, sometimes known as a draft large language model (or as a draft model or an approximation model), to execute (e.g., sequentially or in parallel) with a larger language model, sometimes known as a target large language model (or as a target model). In such cases, the draft model can generate speculatively additional tokens in sequence and probabilities used for sampling these additional tokens based on a current set of accepted tokens. The target model can generate tokens based on the tokens generated by the draft model. To generate a result, the target model can perform rejection sampling on a per-token basis to accept or reject individual tokens generated by the draft model such that the draft model and the target model have similar probability distributions.

In some aspects, the draft model may be a pruned version of the target model chosen such that the draft model and target model have similar probability distributions. In other aspects, the draft model may be a smaller version of the target model (e.g., trained on millions of tokens, instead of hundreds of millions or billions of tokens).

Certain aspects of the present disclosure provide techniques and apparatus for generating responses to a query input into a large language model using speculative decoding techniques in which a single model speculatively generates tokens in response to the query input and verifies previously generated tokens, also referred to herein as “self-speculative decoding.” In self-speculative decoding techniques, a model can speculatively generate one or more tokens and speculatively generate additional tokens based on varying numbers of speculatively generated tokens that are verified by the model. By using the same model to speculatively generate tokens in response to a query and to perform verification of (e.g., rejection sampling on) the speculatively generated tokens, certain aspects of the present disclosure can reduce the computational expenditure involved in training and using generative artificial intelligence models relative to the use of multiple separately trained models for speculatively generating tokens and performing verification of the speculatively generated tokens. Further, the rate at which tokens are generated may be maximized, or at least increased, with self-speculative decoding as compared to other speculative decoding techniques.

### Speculative Decoding in Generative Artificial Intelligence Models

Generally, autoregressive token generation (e.g., in large language models) may take historical tokens as an input in order to generate an output. That is, autoregressive token generation may be represented by the expression:

$${x}_{t} ∼ p ( x \vert {x}_{0} , {x}_{1} , … , {x}_{t - 1} ) \to {x}_{t + 1} ∼ p ( x \vert {x}_{0} , {x}_{1} , … , {x}_{t - 1} , {x}_{t} )$$

where xₜ represents a sequence of tokens generated at time t, having a conditional probability p conditioned on the selection of tokens x₀ through xₜ₋₁, and xₜ₊₁ represents a sequence of tokens generated at time t+1, having a conditional probability p conditioned on the selection of tokens x₀ through xₜ. Generally, a single token may be generated each time an autoregressive model is executed, which means that N inferences may be performed to generate a sequence of N tokens. As discussed above, speculative decoding techniques can be used to accelerate token generation by using a draft model, smaller in size than the target model, that speculatively generates tokens faster than the target model, with the target model being used to verify the tokens (speculatively) generated by the draft model.

In a speculative decoding pipeline, the draft model may speculatively generate n tokens autoregressively, according to the expression:

$${x}_{t + 1}^{draft} ∼ {p}_{t}^{draft} = {p}^{draft} ( x \vert {x}_{0} , … {x}_{t} ) , {x}_{t + 2}^{draft} ∼ {p}_{t + 1}^{draft} , {x}_{t + n}^{draft} ∼ {p}_{t + n - 1}^{draft}$$

where t corresponds to a point in time,

$${p}_{t}^{d raft}$$

corresponds to the conditional probability distribution associated with a selected token x at time t conditioned on the selection of tokens x₀ through xₜ₋₁, and

$${x}_{t}^{d raft}$$

represents a token x speculatively generated at time t by the draft model.

The target model takes the generated n tokens and processes the n tokens in parallel to generate probability distributions for each of the n tokens, according to the expression:

$$[ {p}_{t}^{target} , {p}_{t + 1}^{target} , … , {p}_{t + n}^{target} ] = {[ {p}^{target} ( x \vert {x}_{0} , … {x}_{t} , {x}_{t + 1}^{draft} , … , {x}_{t + k}^{draft} ) ]}_{k = 1 , 2 , … , n}$$

where k corresponds to a token index relative to the generated n tokens and

$${p}_{t}^{target}$$

corresponds to a probability distribution generated by the target model at time t for the tokens x generated by the draft model.

The target model can then verify the tokens generated by the draft model by comparing distributions from the draft model and target model to determine whether a token is accepted or rejected. A given token

$${x}_{t + k}^{draft}$$

may be accepted when

$$f ( {p}_{k}^{draft} , {p}_{k}^{target} ) < α ,$$

for some function ƒ and some threshold α (also known as an acceptance rate). Otherwise, the token may be rejected. The final token may then be generated at the first rejection position or at the last position n based on some function

$$g ( {p}_{k}^{draft} , {p}_{k}^{target} ) .$$

Speculative decoding, with an acceptance rate of α, may result in cost reductions relative to using a single autoregressive model to generate tokens iteratively. Inference cost savings, relative to iterative token generation, may be represented by the expression:

$${C}^{AR} = {NC}^{target} \to {C}^{SD} = {nNC}^{draft} + \frac{N}{α + 1} {C}^{target}$$

where N corresponds to a number of tokens, C^{AR} corresponds to a computational cost using an acceptance rate of α, C^{target} corresponds to a computational cost of generating a set of tokens using the target model, C^{draft} corresponds to a computational cost of generating a set of tokens using the draft model, C^{SD} corresponds to a computational cost of speculatively generating a set of tokens using the draft model, and n corresponds to a number of tokens generated speculatively in a single pass through an autoregressive model. Consider an example in which N=1000, C^{target}=10, C^{draft}=1, n=4, and α=3. In such an example, speculative decoding may result in a 35% reduction in computational expense relative to autoregressive iterative token generation alone.

However, speculative decoding on a per-token basis, as discussed, may impose limits on the rate at which tokens are generated, as a first token may be sampled individually by a draft model and then verified by a target model before the next token is sampled by the draft model and verified by the target model. That is, generating a response to an input prompt using per-token speculative decoding techniques may involve executing the draft model and target model for each token generated as part of a response to the input prompt, which may use significant amounts of computational resources (e.g., processor time, memory, memory bandwidth, etc.) in order to generate the response.

### Example Self-Speculative Decoding in Generative Artificial Intelligence Models

In some aspects, speculative decoding, may be achieved using a single generative artificial intelligence model that combines the functionality of a draft model used to speculatively generate tokens and a target model used to verify and accept the speculatively generated tokens. In doing so, draft token generation, target token generation, and token acceptance may be parallelized in a single generative artificial intelligence model. Using a single generative artificial intelligence model may, for example, reduce the computational expense involved in generating both a target model and a draft model, increase the performance of generative tasks by executing token verification and speculative generation in one pass through the single generative artificial intelligence model, reduce the amount of memory used in storing models used for speculative decoding in generative tasks, and so on.

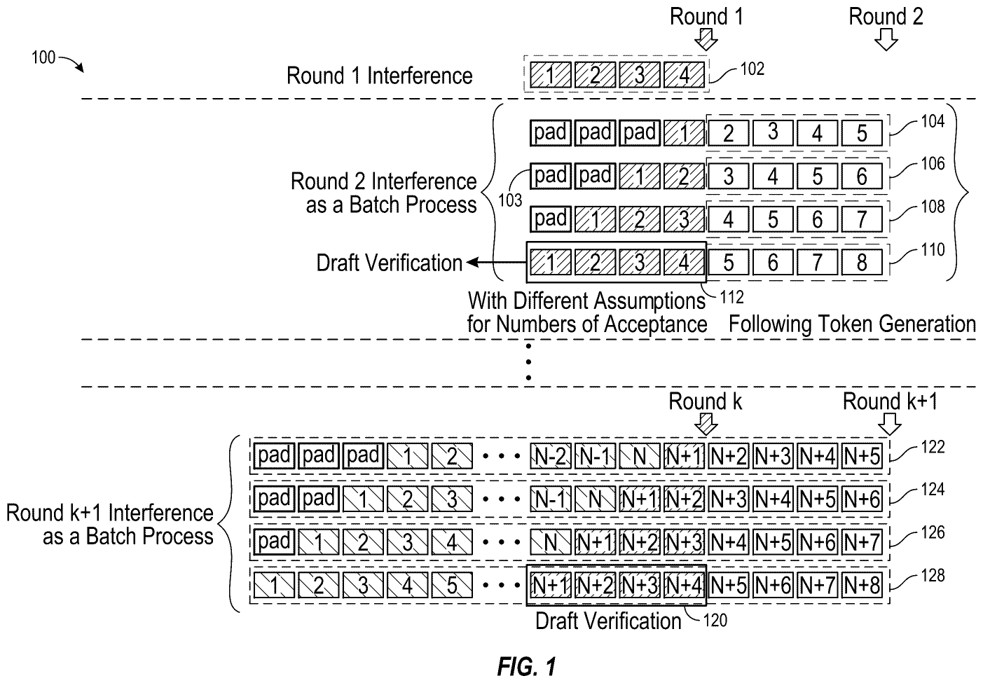

FIG. 1 illustrates an example pipeline 100 for self-speculative decoding in generative artificial intelligence models, according to certain aspects of the present disclosure.

As illustrated, the pipeline 100 uses a single generative artificial intelligence model to speculatively generate tokens and verify the speculatively generated tokens. During a first inference round in the pipeline 100, a first set of tokens 102 is speculatively generated. As illustrated, for example, the first set of tokens 102 may include tokens 1 through 4 and may be provided as input during a second round in the pipeline 100 to speculatively generate the next set of tokens as a batch process in which multiple sets of tokens are generated. While the first set of speculatively generated tokens is processed by the single generative artificial intelligence model, the single generative artificial intelligence model continues to speculatively generate a plurality of second sets of draft tokens 104, 106, 108, and 110 in a second inference round in the pipeline 100.

In generating the second sets of draft tokens 104, 106, 108, and 110, assumptions may be made for different numbers of accepted tokens from the first set of tokens 102. For example, as illustrated, the second set of draft tokens 104 may assume acceptance of the first draft token from the first set of tokens 102 and may include a speculatively generated set of tokens based on acceptance of the first token. The second set of draft tokens 106 may assume acceptance of the first and second draft tokens from the first set of tokens 102 and include a speculatively generated set of tokens based on acceptance of the first and second tokens. The second set of draft tokens 108 may assume acceptance of the first through third draft tokens from the first set of tokens 102 and include a speculatively generated set of tokens based on acceptance of the first through third tokens. Finally, the second set of draft tokens 110 may assume acceptance of all four tokens from the first set of tokens 102 and include a speculatively generated set of tokens based on acceptance of all four tokens. In various aspects, for the cases in which fewer tokens than the number of tokens included in the first set of tokens 102 are assumed to be accepted, padding 103 (e.g., null values, predefined constants, etc.) can be added so that each assumption is of the same length.

Once the single generative artificial intelligence model completes rejection sampling on the speculatively generated set of tokens, the single generative artificial intelligence model selects the set of speculatively generated tokens associated with the set of accepted tokens from the first set as input to the single generative artificial intelligence model for another inference round in which tokens are speculatively generated using the single generative artificial intelligence model. In this example, it may be seen that all four tokens in the first set of tokens 102 have been accepted by the single generative artificial intelligence model as a draft verification 112, and thus, the set of tokens 110 may be used for further speculative generation of tokens using the single generative artificial intelligence model.

The process above may be continued until a terminating event occurs. Successive rounds of speculative generation may be based on assumptions of the number of tokens from a previous round of speculative generation being accepted by the single generative artificial intelligence model. For example, as illustrated in FIG. 1, sets of draft tokens 122, 124, 126, and 128 may be generated in the k+1^{th} round of inferencing with the tokens included in the sets of draft tokens being based on a number of speculatively generated tokens beyond the N accepted tokens generated in the k−1^{th} round of inferencing. In this example, it may be seen that the four speculatively generated tokens generated during the k^{th} round of inferencing have been accepted as a draft verification 120, and the tokens N+5 through N+8 may be used for further speculative generation of tokens using the single generative artificial intelligence model.

In some aspects, a terminating event may include the generation of a special token used to denote the end of a response (e.g., that no further tokens can plausibly be included in a response due to the probabilities associated with these tokens falling below a threshold probability value for acceptance). A terminating event may, in some aspects, be reached when a threshold number of tokens have been generated.

In some aspects, when all tokens from a previous round of speculative token generation are rejected by the single generative artificial intelligence model, the process can restart with the last set of accepted tokens, plus a token sampled from a final distribution (e.g., as discussed above), being provided as input into the single generative artificial intelligence model.

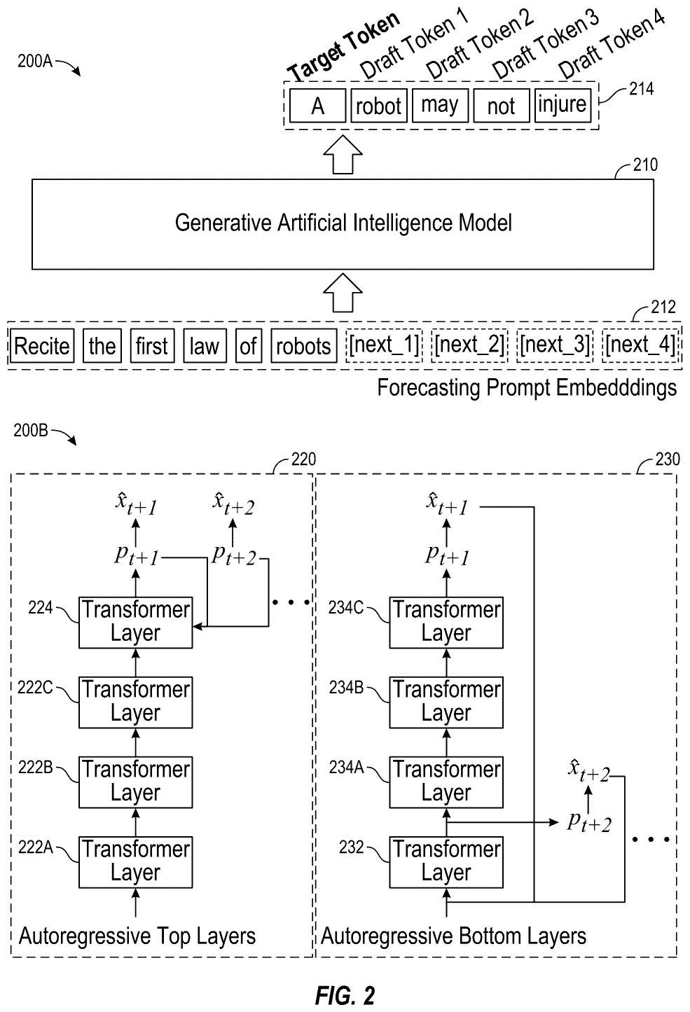

FIG. 2 illustrates example architectures 200A, 200B for self-speculative decoding in generative artificial intelligence models, according to certain aspects of the present disclosure. The example architectures 200A and 200B may both allow for the generation of multiple tokens in any pass through the model, such as in the generation of tokens illustrated in FIG. 1, as discussed above.

In the example architecture 200A, a generative artificial intelligence model 210 may be trained to generate multiple forecast prompt embeddings 212, appended to an input set of tokens, to allow for parallel generation of multiple output tokens 214. These forecast prompt embeddings 212 may be embeddings that correspond to tokens that are included in a response to an input prompt (including any previously generated and accepted tokens). The generative artificial intelligence model 210 may be a generative artificial intelligence model, such as a pre-trained large language model or other pre-trained generative artificial intelligence model, updated using various fine-tuning techniques. For example, a generative artificial intelligence model used to generate textual responses to textual inputs (also known as a large language model) may be updated using techniques such as low-rank adaptation (LoRA) of large language models.

In the example architecture 200B, generative artificial intelligence models may be implemented as a partial autoregressive model. Inference operations, used to speculatively generate tokens, may be performed using a subset of layers in the partial autoregressive model (e.g., the top n layers of the model or the bottom n layers of the model). In doing so, the layers used to speculatively generate tokens may create context which may allow for causality and/or other relationships to be modeled for the speculatively generated tokens which may be fed as input into the portion of the model that verifies the tokens as valid responses to the input prompt.

The architecture 200B may be implemented in various manners such that autoregressive inference, and the generation of multiple sets of tokens for acceptance and/or rejection, can be generated using a small number of autoregressive layers in a generative artificial intelligence model. In example implementation 220, a generative artificial intelligence model may include a plurality of non-autoregressive layers 222A-222C and an autoregressive layer 224. The layers in the generative artificial intelligence model may be organized into a stack, with the lowest layer in the stack corresponding to the layer that receives an input for processing and the highest layer in the stack corresponding to the layer that generates an output. In the implementation 220, the non-autoregressive layers 222A-222C may be placed at the bottom of the stack, and the autoregressive layer 224 may be placed at the top of the stack. In contrast, in example implementation 230, the layers of the generative artificial intelligence model may be organized such that an autoregressive layer 232 is placed at the bottom of the stack, and non-autoregressive layers 232A-232C are placed at the top of the stack. These autoregressive layers 224 and 232 may operate, for example, in a loop to continually generate and accept tokens to be output as a response to an input prompt (and, in some aspects, previously generated tokens included as a partial response to the input prompt).

### Example Efficient Self-Speculative Decoding in Generative Artificial Intelligence Models

As discussed, self-speculative decoding allows for the use of a single generative artificial intelligence model acting as both the draft model and the target model to generate a response to an input prompt. By using a single generative artificial intelligence model as the draft model and the target model in generating a response to an input prompt, self-speculative decoding may allow for increases in the speed at which generative artificial intelligence models generate a response to an input prompt.

To further increase the speed at which tokens are generated using self-speculative decoding techniques and allow self-speculative decoding techniques to be used in generative artificial intelligence models that generate an output from a multimodal input (e.g., an input including data in multiple modalities, such as an image and an accompanying prompt, audio content and an accompanying prompt, etc.), certain aspects of the present disclosure provide techniques for generating tokens based on forecasted embedding inputs into a generative artificial intelligence model. These forecasted embedding inputs may be accompanied by a forecasted prefix injected into the key-value (KV) data used by a generative artificial intelligence model to generate a response to the input of the generative artificial intelligence model.

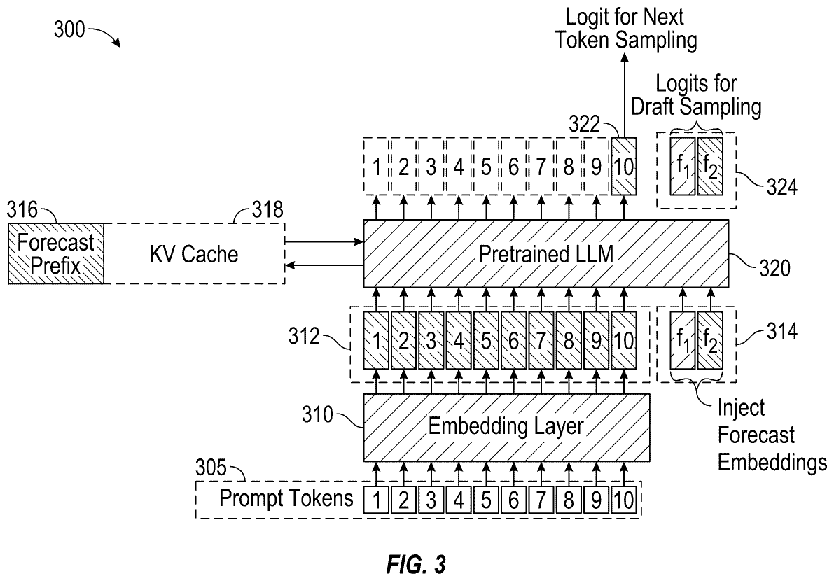

FIG. 3 illustrates an example pipeline 300 for efficient self-speculative decoding in generative artificial intelligence models based on forecasted embedding inputs, according to certain aspects of the present disclosure. As illustrated, the pipeline 300 includes an embedding layer 310 and a pretrained generative artificial intelligence model 320 (labeled as a pretrained large language model (LLM) in FIG. 3, though it should be understood by one of ordinary skill in the art of machine learning that the generative artificial intelligence model may be any appropriate generative model that is trained to generate a response to an input prompt).

To generate a response in the pipeline 300, the embedding layer 310 may project a tokenized version of an input prompt 305 into a set of embeddings 312 in an embedding space. The embeddings 312 generated from the tokenized version of the input prompt 305 may be accompanied by a number of forecasted token embeddings 314 associated with future predictions of inputs into the generative artificial intelligence model 320. These forecasted token embeddings 314, for example, may be embeddings associated with predicted tokens corresponding to words or parts of words predicted to be part of an output that is subsequently appended to the input prompt for future generation of additional portions of the response to the input prompt in subsequent inferencing rounds using the generative artificial intelligence model 320. In some aspects, the forecasted token embeddings 314 input into the generative artificial intelligence model 320 may be accompanied by a forecasted prefix 316 prepended to an internal cache 318 (labeled as a KV (key-value) cache in FIG. 3, though it should be recognized that the internal cache may be any appropriate cache that can be used by the generative artificial intelligence model 320 to store and access previously processed data for subsequent inferencing) used by the generative artificial intelligence model 320 for generating a response to the input prompt. As illustrated, the forecasted prefix 316 may be a prefix for the internal cache 318 (e.g., a key-value cache or other data cache) used by transformer layers of a large language model, large multimodal model, or other transformer-based generative artificial intelligence model to condition the generation of attention outputs which are used in sampling tokens to serve as a response to the input prompt.

Generally, the forecasted token embeddings 314 may be generated by a machine learning model trained based on minimizing, or at least reducing, a loss function between tokens predicted by the generative artificial intelligence model using the forecasted token embeddings 314 and ground-truth tokens in a training data set. Generally, the forecasted token embeddings 314 may include any number M of forecasted embeddings, and the forecasted token embeddings 314 may be introduced as inputs into the generative artificial intelligence model 320 in conjunction with the embeddings 312 generated from the tokenized version of the input prompt 305. For example, the forecasted token embeddings 314 may be appended to the end of the embeddings 312 generated from the tokenized version of the input prompt 305 or after the last token accepted from a previous inferencing round. The number of forecasted tokens for which the generative model is trained may define the maximum draft length during inferencing time.

As illustrated, in some aspects, the forecasted prefix 316 may be a set of learnable parameters added to the internal cache 318 used by the generative artificial intelligence model 320 to aid in predicting future output tokens. Generally, the forecast prefix 316 may be masked during processing so that the forecast prefix 316 is used by the generative artificial intelligence model 320 in processing the forecasted token embeddings 314 (e.g., in calculating attention for the forecasted token embeddings 314 appended to the embeddings 312 generated from the tokenized version of the input prompt 305), but not used by the generative artificial intelligence model 320 in processing the tokens corresponding to the embeddings 312 generated from the tokenized version of the input prompt 305 itself. This attention mask may, for example, model dependencies between different types of tokens (e.g., input tokens, prefix tokens, draft tokens, forecast tokens, etc.).

The output of the generative artificial intelligence model 320, as illustrated, may include a plurality of tokens. A first output token 322 may be a token that is deemed to be valid and accepted by the generative artificial intelligence model 320 during a verification round, as the first token generated by the generative artificial intelligence model 320 may typically be accepted as a valid token responsive to the input prompt. A set of speculatively generated draft tokens 324 may also be generated by the generative artificial intelligence model 320, as discussed above. Generally, these speculatively generated draft tokens 324 may be generated based on assumptions that prior tokens are accepted, resulting in the generation of a draft token tree or other data structure in which different sets of tokens (e.g., represented by different navigable paths through a token tree) correspond to different candidate responses to the input prompt.

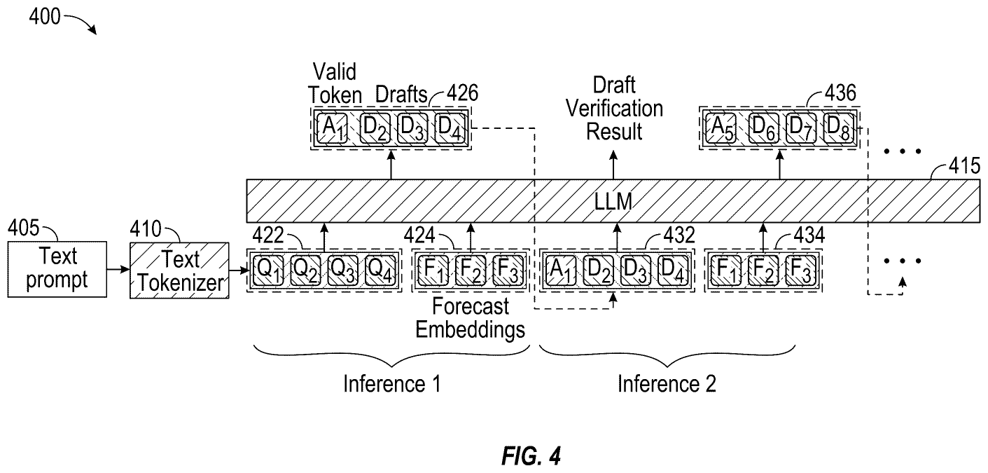

FIG. 4 illustrates an example 400 of generating a response to a textual input prompt 405 using self-speculative decoding based on forecasted embedding inputs, according to certain aspects of the present disclosure.

As illustrated, in the example 400, the textual input prompt 405 (labeled “Text prompt”) may be received and tokenized into input tokens Q₁ through Q₄ (amongst others, not illustrated in FIG. 4, and collectively referred to herein as “input tokens 422”) by a text tokenizer 410. Embedding representations of the input tokens 422 may be accompanied by a set of forecasted embedding inputs F₁ through F₃ (amongst others, not illustrated in FIG. 4, and collectively referred to herein as “forecasted embedding inputs 424”) as input into a generative artificial intelligence model 415 (labeled “LLM” in FIG. 4). As discussed above, the number of forecasted embedding inputs 424 appended to the tokenized input (e.g., the input tokens 422) may be defined based on the number of forecasted embedding tokens with which the generative artificial intelligence model is trained. An output 426 of the initial round of inferencing may be a valid token A₁ (since the initial token generated by the generative artificial intelligence model 415 may be deemed valid) and a plurality of draft tokens D, labeled “D₂,” “D₃,” and “D₄” (though it should be understood that any number of speculatively generated draft tokens may be output by the generative artificial intelligence model 415).

In a second inferencing round (e.g., an inferencing round following the initial inferencing round), the output 426 of the initial inferencing round, including the valid token A₁ and the draft tokens D₂ through D₄, may be input into the generative artificial intelligence model 415 for verification. Further, the valid token A₁ and the draft tokens D₂ through D₄ may be accompanied by a new set of forecasted embedding tokens F₁ through F₃ (collectively referred to herein as “forecasted embedding tokens 434”), and (1) verified tokens 432 from the output set of tokens including A₁ and D₂ through D₄ and (2) the forecast embedding tokens 434 may be input into the generative artificial intelligence model 415 to generate another output 436. This output 436, as illustrated, includes a valid token A₅ and a plurality of speculatively generated draft tokens D₆ through D₈.

The process of verifying draft tokens generated during a prior inferencing round and generating a new set of output tokens, including a valid token and a plurality of draft tokens, based on previously generated/verified tokens and forecasted embedding tokens, may continue until a terminating condition is reached. This terminating condition may include, for example, reaching a maximum output length for a response generated by the generative artificial intelligence model 415, the generation and validation by the generative artificial intelligence model 415 of a terminating token indicating that the generative artificial intelligence model 415 has completed generating a response to the input prompt 405, or the like.

In the example 400, as can be seen, multiple tokens may be generated during each inferencing round. By doing so, certain aspects of the present disclosure may increase the token generation rate relative to autoregressive decoding techniques in which a single token is generated during each inferencing round until a terminating condition is reached.

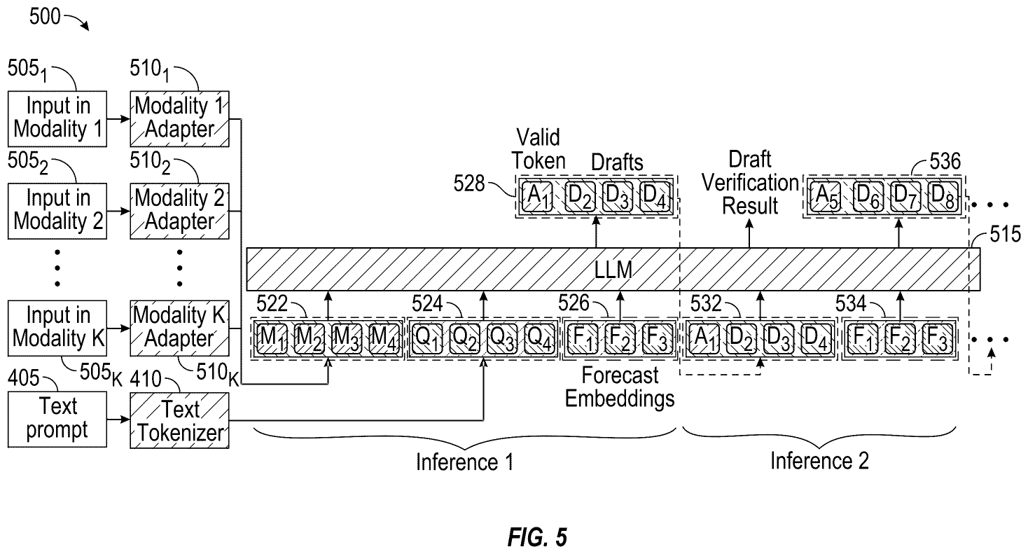

FIG. 5 illustrates an example 500 of generating a response to a multimodal input prompt using self-speculative decoding based on forecasted embedding inputs, according to certain aspects of the present disclosure.

As illustrated, in the example 500, an input (e.g., an input prompt) for processing by a generative artificial intelligence model 515 may include data 505₁ through 505ₖ in one or more modalities (e.g., modalities 1 through K), such as a visual modality (e.g., an image) or other non-textual modality, and a text modality (represented by the textual input prompt 405). The different modalities of data 505₁ through 505ₖ and the textual input prompt 405 composing the input prompt may be processed independently into different embeddings. For example, as illustrated, the non-textual components of the input prompt (e.g., the data in 505₁ through 505_{K} in modalities 1 through K) may be processed into the tokens M₁ through M₄ (collectively referred to herein as “tokens 522”) by the corresponding modality adapters 510₁ through 510_{K}, while the text of the input prompt 405 may be processed into the tokens Q₁ through Q₄ (collectively referred to herein as “tokens 524”). Finally, similar to the example 400 illustrated in FIG. 4, a plurality of forecasted embedding tokens F₁ through F₃ (collectively referred to herein as “forecasted embedding tokens 526”) may be generated based on the tokens 522 and tokens 524 Q₁ through Q₄.

As illustrated, during a first round of inferencing, the tokens 522 (tokens M₁ through M₄) and tokens 524 (tokens Q₁ through Q₄) and the forecasted embedding tokens 526 (tokens F₁ through F₃) may be input into the generative artificial intelligence model 515 (labeled “LLM”). The generative artificial intelligence model 515 may generate an output 528 of the first inferencing round. The output 528 generally includes a valid token A₁ and a plurality of draft tokens D₂ through D₄. This output 528 may be verified by the generative artificial intelligence model 515, and in a second round of inferencing (e.g., an inferencing round subsequent to the first round of inferencing), verified tokens 532 from the first round of inferencing, along with another set of forecasted embedding tokens 534 generated based on the verified tokens 532, may be input into the generative artificial intelligence model 515. The generative artificial intelligence model 515 then generates an output 536 for the second round of inferencing, which, as illustrated, includes a valid token A₅ and a plurality of speculatively generated draft tokens D₆ through D₈. As with the process illustrated in FIG. 4, inferencing operations may continue until a terminating condition is reached.

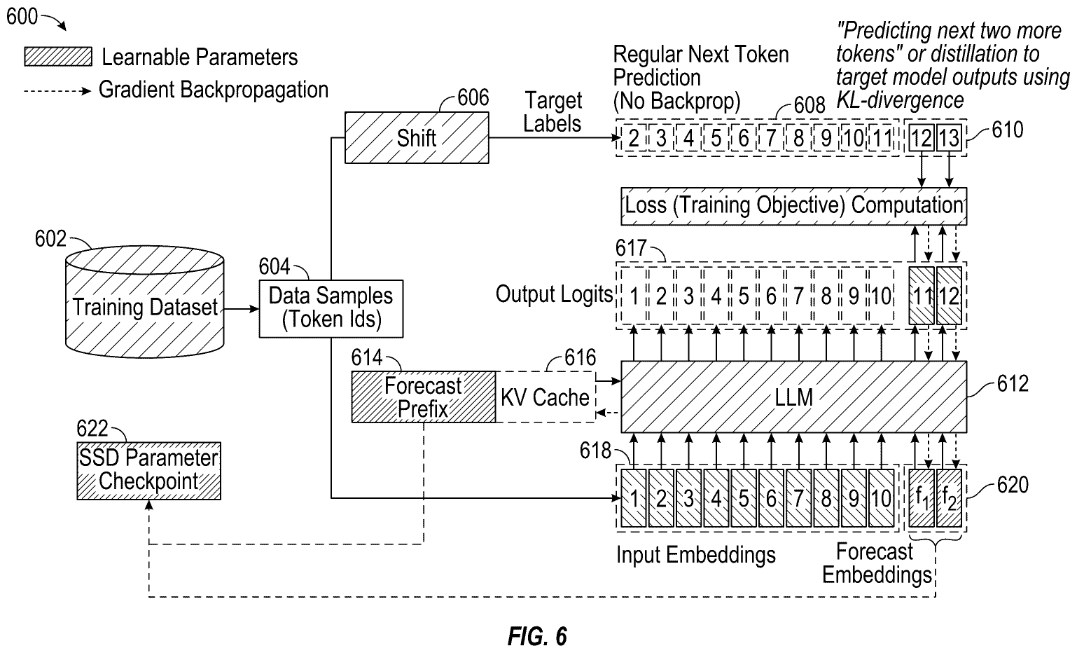

FIG. 6 illustrates an example 600 for training a generative artificial intelligence model for self-speculative decoding based on forecasted embedding inputs, according to certain aspects of the present disclosure.

As illustrated, in the example 600, a training data set 602 may be used to train a self-speculative decoding parameter predictor to generate forecast embeddings ƒ and a forecast prefix based on a loss computation between ground-truth tokens in the training data set and tokens generated based on the forecast embeddings. Generally, the training data set 602 may include a plurality of example responses to an input query. Because samples 604 in the training data set 602 may include more tokens than a generative artificial intelligence model 612 (labeled “LLM,” though it should be recognized that the generative artificial intelligence model 612 may include any appropriate artificial intelligence model that can generate a response to an input query) can generate in a single round of inferencing, a shift 606 may be applied to a sample 604 from the training data set 602 to generate a ground-truth target set of tokens 608, 610. Based on the ground-truth target set of tokens 608, 610, a self-speculative decoding parameter predictor may be trained to generate forecast tokens.

To train the self-speculative decoding parameter predictor, a portion 618 of a sample 604, along with one or more forecasted embeddings 620, may be input into the generative artificial intelligence model 612 for processing. The generative artificial intelligence model 612 may generate an output 617, which includes a first token that may be deemed a valid token and a plurality of tokens after the first token that are speculatively generated tokens. The output 617 may, as discussed, be generated based on cached information in a cache 616 (e.g., a KV cache), as well as a forecast prefix 614 generated by the self-speculative decoding parameter predictor and prepended to the cached information from the cache 616.

A loss may be calculated between the ground-truth tokens 608, 610 and the output 617. This loss may be backpropagated (e.g., via gradient descent or another backpropagation technique) to refine the self-speculative decoding parameter predictor to generate forecast embeddings 620 and (in some aspects) forecast prefixes 614 that result in the generation of draft tokens that more closely approximate the ground-truth tokens in the training data set 602. For example, as illustrated, a loss backpropagated through the generative artificial intelligence model 612 to train a self-speculative decoding parameter predictor may be based on a difference between the ground-truth tokens 610 and the corresponding speculatively decoded draft tokens in the output 617 (e.g., tokens 11 and 12 in the output 617).

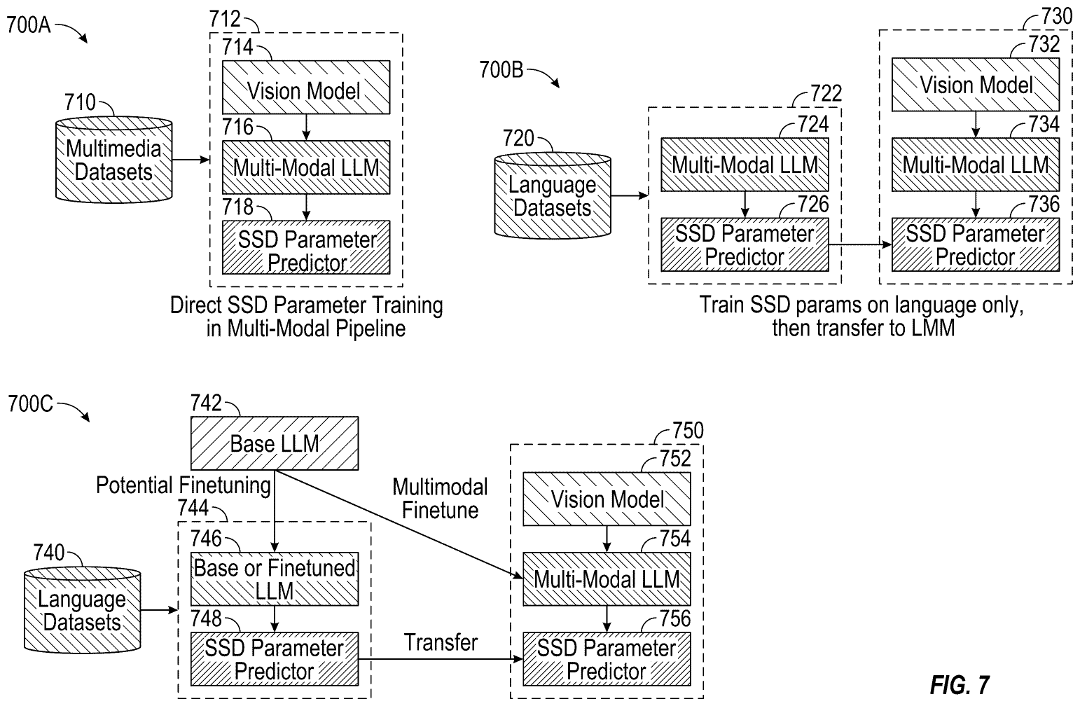

FIG. 7 illustrates various examples 700A, 700B, 700C of training a generative artificial intelligence model for self-speculative decoding for multimodal inputs, according to certain aspects of the present disclosure. Because self-speculative decoding generative artificial intelligence models generally are robust against differences in the training and test data sets, different data modalities, and finetuning techniques, various techniques can be used to efficiently train a generative artificial intelligence model to process multimodal prompts.

As illustrated in example 700A, a multimodal data set 710 may be used to train a self-speculative decoding (SSD) generative artificial intelligence model 712. The model 712 may include a vision model 714, a multimodal large language model 716, and a self-speculative decoding parameter predictor 718. The multimodal data set 710 may be used to train the vision model 714 to generate embedding representations of content in a visual modality, and based on parameter transfer techniques, be used to train the multimodal large language model 716 to generate textual responses to a multimodal input. The parameters of the multimodal large language model 716 may, in turn, be transferred to the self-speculative decoding parameter predictive model 718 to initiate training of the self-speculative decoding parameter predictive model 718.

In some aspects, as illustrated in example 700B, a language data set 720 may be used in a first training stage 722 to train a large language model 724 and a self-speculative decoding parameter predictor 726. In a second training stage 730, a vision model 732 may be trained, and the self-speculative decoding parameter predictor 726 may be transferred to a self-speculative decoding parameter predictor 736 of a multimodal generative artificial intelligence model 734 to forecast embedding tokens for inputs into the multimodal generative artificial intelligence model. The self-speculative decoding parameter predictor 736 may, thus, be trained on a language data set alone.

In other aspects, as illustrated in example 700C, a pretrained (or “base”) large language model 742 may be used as the base model for generating a self-speculative decoding parameter predictive model. In doing so, during a first training stage 744, the base model 742 may optionally be finetuned based on a language data set 740 to generate a finetuned large language model 746, and a self-speculative decoding parameter predictor 748 may be trained based on minimizing, or at least reducing, a difference between speculatively decoded tokens and ground-truth tokens in the language data set 740. The parameters of the self-speculative decoding parameter predictor 748 trained for a large language model may be transferred to a corresponding self-speculative decoding parameter predictor 756 of a multimodal generative artificial intelligence model 750. In addition to the self-speculative decoding parameter predictor 756, the model 750 may also include a vision model 752 trained to generate embedding representations of content and a multimodal large language model 754 generated based on finetuning of the base large language model 742.

In some aspects, the training of the generative artificial intelligence model, or different components thereof (e.g., a vision model that generates embedding representations of content in a visual modality, the self-speculative decoding parameter predictive model, etc.) may be based on a probability distribution associated with a draft set of tokens generated by a draft model and a probability distribution associated with a target set of tokens generated by a target model (which may be represented by ground-truth token sets in the training data set). The draft model may, in some aspects, be trained based on a distillation loss between the probability distribution associated with the draft set of tokens and the probability distribution associated with the target set of tokens. This loss may be backpropagated to the draft model to refine the draft model such that the behavior of the draft model approximates the behavior of the target model.

In some aspects, the self-speculative decoding parameter predictors 718, 726, 736, 748, and 756 may be truncated versions of a generative artificial intelligence model for which the self-speculative decoding parameter predictors generate forecasted parameters for use as an input for processing. Generally, a truncated version of the generative artificial intelligence model may include a model that includes a subset of the layers of the generative artificial intelligence model or is otherwise smaller in size than the generative artificial intelligence model from which the self-speculative decoding parameter predictors are derived.

By training the self-speculative decoding parameter predictive model using a large language model (which may be refined, for example, based on reinforcement learning using human feedback (RLHF) or other refinement techniques) and transferring the self-speculative decoding parameter predictive model using a large language model to a multimodal generative artificial intelligence model, certain aspects of the present disclosure may allow for an increase in token throughput for a task, such as the generation of a description of an image, relative to autoregressive models that generate tokens included in a response using autoregressive decoding techniques.

### Example Operations for Generating Responses to Input Queries Using Self-Speculative Decoding in Generative Artificial Intelligence Models

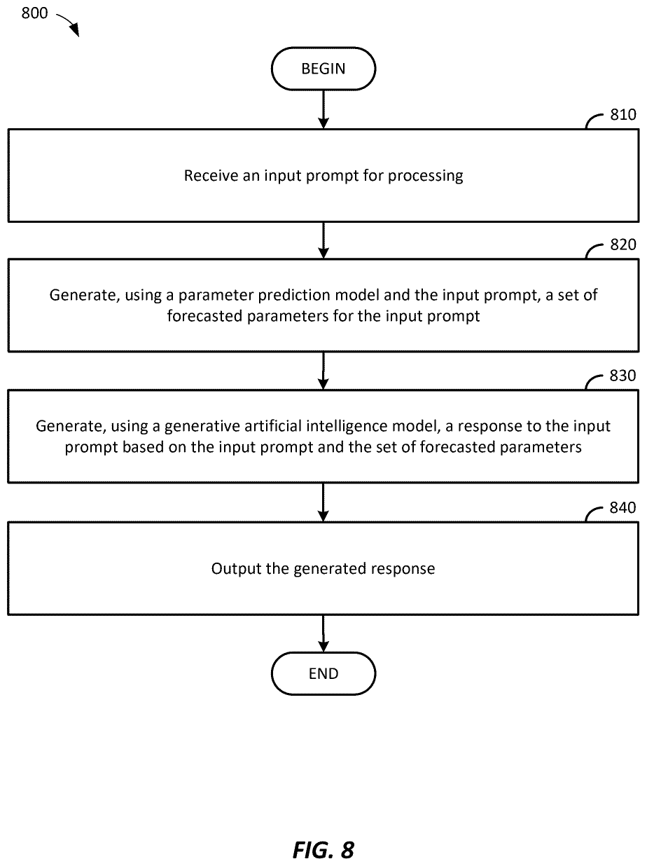

FIG. 8 illustrates example operations 800 for efficient self-speculative decoding in generative artificial intelligence models based on forecasted parameters (e.g., embedding inputs), according to certain aspects of the present disclosure. The operations 800 may be performed, for example, by a computing device on which a generative artificial intelligence model can be deployed to perform inferencing operations on a multimodal input, such as a smartphone, a tablet computer, a laptop computer, a desktop computer, a cloud computing instance, or the like.

As illustrated, the operations 800 begin at block 810, with receiving an input prompt for processing. As discussed, the input prompt may be a unimodal prompt (e.g., a text prompt requesting a textual response to the input) or a multimodal prompt (e.g., a text prompt requesting a textual response to the input and data in a multimedia (e.g., audio, visual, etc.) modality to which the textual response is to be related.

At block 820, the operations 800 proceed with generating a set of forecasted parameters for the input prompt using a parameter prediction model and the input prompt. As discussed, the set of forecasted parameters may include a set of forecasted embedding tokens for use as additional inputs into a generative artificial intelligence model. In some aspects, the set of forecasted parameters may further include a prefix to be prepended to a key-value cache of the generative artificial intelligence model for use in speculatively generating a portion of the response to the input prompt.

At block 830, the operations 800 proceed with generating, using a generative artificial intelligence model, a response to the input prompt based on the input prompt and the set of forecasted parameters.

In some aspects, generating the response to the input prompt may include masking a forecasted prefix in a cache associated with the generative artificial intelligence model. The mask may be defined such that the forecasted prefix is used to process the one or more forecast tokens and not used to process tokens associated with the input prompt. In some aspects, the forecast tokens may include tokens speculatively decoded by the generative artificial intelligence model based on generation of an initial response token to the input prompt.

In some aspects, the generated response may include a valid token and one or more speculatively generated tokens. The one or more speculatively generated tokens may, in some aspects, be represented by a token tree, with each path through the token tree representing a different sequence of tokens that may be validated in a subsequent inferencing round. The valid token and the validated draft tokens (if any) may be appended to the input prompt used in the previous inferencing round, and the combination of the input prompt from the previous inferencing round, the valid token, and the validated draft tokens may serve as inputs for a subsequent inferencing round.

In some aspects, generating the response to the input prompt may include generating a set of value tokens from data in a first modality in the input prompt and generating a set of query tokens from data in a second modality in the input prompt. The response may be generated based on the set of value tokens and the set of query tokens. The first modality may be a visual data modality, and the second modality may be a text data modality, for example.

At block 840, the operations 800 proceed with outputting the generated response.

In some aspects, a number of parameters in the set of forecasted parameters is based on a maximum draft length associated with the generative artificial intelligence model.

In some aspects, the parameter prediction model comprises a truncated version of the generative artificial intelligence model.

In some aspects, the input prompt comprises a set of tokens generated in a prior inferencing round. The operations 800 further include identifying a set of verified tokens from the set of tokens generated in the prior inferencing round, wherein the set of forecasted tokens is generated based on the set of verified tokens.

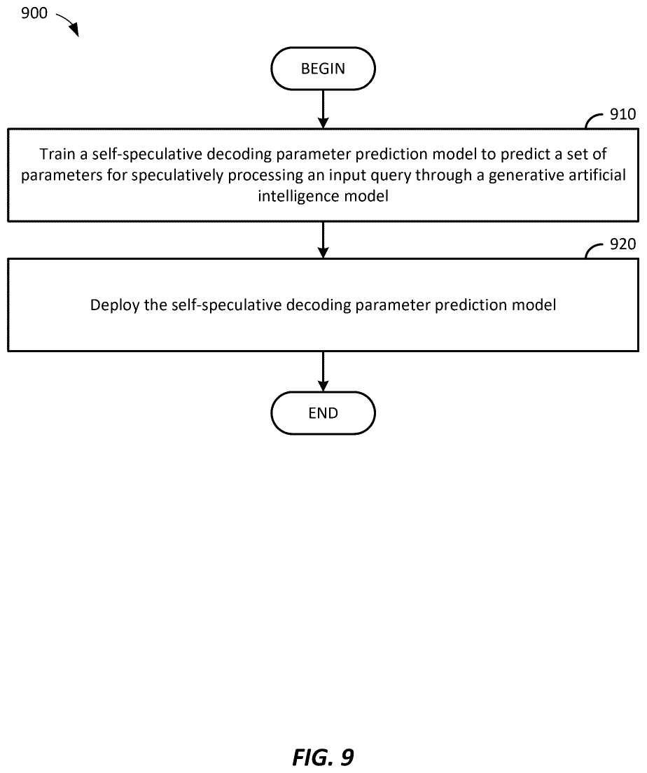

FIG. 9 illustrates example operations 900 for training a generative artificial intelligence model for efficient self-speculative decoding based on forecasted parameters (e.g., embedding inputs), according to certain aspects of the present disclosure. The operations 900 may be performed, for example, by a computing device on which a generative artificial intelligence model can be trained, such as a server computer, a computing cluster, a cloud computing instance, or the like.

As illustrated, the operations 900 begin at block 910, with training a self-speculative decoding prediction model to predict a set of parameters for speculatively processing an input query through a generative artificial intelligence model. As discussed, the self-speculative decoding prediction model may be trained based on minimizing, or at least reducing, a loss calculated between speculatively decoded draft tokens generated by the generative artificial intelligence model using an input prompt and parameters generated by the self-speculative decoding prediction model and ground-truth tokens included in a training data set. The training data set may include, for example, tokenized versions of input prompts and responses to those input prompts.

At block 920, the operations 900 proceed with deploying the self-speculative decoding prediction model.

### Example Processing Systems for Speculative Decoding in Generative Artificial Intelligence Models Based on Forecasted Tokens

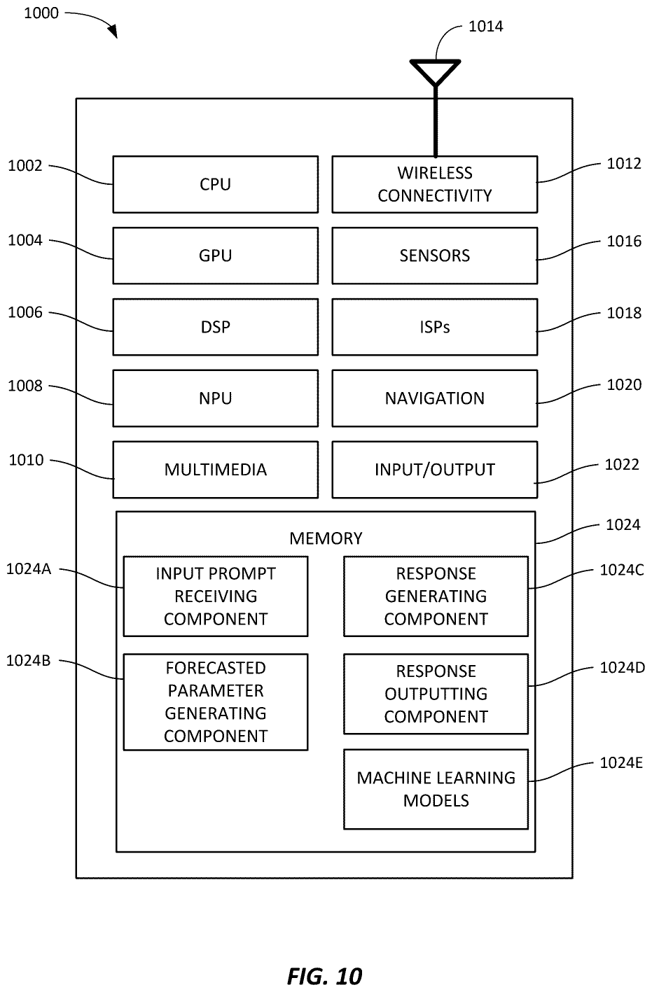

FIG. 10 depicts an example processing system 1000 for generating a response to a query input into a generative artificial intelligence model based on speculative decoding and forecasted parameters, such as described herein, for example, with respect to FIG. 8.

The processing system 1000 includes a central processing unit (CPU) 1002, which in some examples may be a multi-core CPU. Instructions executed at the CPU 1002 may be loaded, for example, from a program memory associated with the CPU 1002 or may be loaded from a memory partition (e.g., of a memory 1024).

The processing system 1000 also includes additional processing components tailored to specific functions, such as a graphics processing unit (GPU) 1004, a digital signal processor (DSP) 1006, a neural processing unit (NPU) 1008, and a connectivity component 1012.

An NPU, such as the NPU 1008, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 1008, are configured to accelerate the performance of common machine learning tasks, such as image classification, machine translation, object detection, and various other predictive models. In some examples, a plurality of NPUs may be instantiated on a single chip, such as a system on a chip (SoC), while in other examples, such NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new piece through an already trained model to generate a model output (e.g., an inference).

In some implementations, the NPU 1008 is a part of one or more of the CPU 1002, the GPU 1004, and/or the DSP 1006. These may be located on a user equipment (UE) in a wireless communication system or another computing device.

In some examples, the connectivity component 1012 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The connectivity component 1012 may be further coupled to one or more antennas 1014.

The processing system 1000 may also include one or more sensor processing units 1016 associated with any manner of sensor, one or more image signal processors (ISPs) 1018 associated with any manner of image sensor, and/or a navigation processor 1020, which may include satellite-based positioning system components (e.g., GPS or GLONASS) as well as inertial positioning system components.

The processing system 1000 may also include one or more input and/or output devices 1022, such as screens, touch-sensitive surfaces (including touch-sensitive displays), physical buttons, speakers, microphones, and the like.

In some examples, one or more of the processors of the processing system 1000 may be based on an ARM or RISC-V instruction set.

The processing system 1000 also includes the memory 1024, which is representative of one or more static and/or dynamic memories, such as a dynamic random access memory, a flash-based static memory, and the like. In this example, the memory 1024 includes computer-executable components, which may be executed by one or more of the aforementioned processors of the processing system 1000.

In particular, in this example, the memory 1024 includes an input prompt receiving component 1024A, a forecasted parameter generating component 1024B, a response generating component 1024C, a response outputting component 1024D, and machine learning models 1024E. The depicted components, and others not depicted, may be configured to perform various aspects of the methods described herein.

Generally, the processing system 1000 and/or components thereof may be configured to perform the methods described herein.

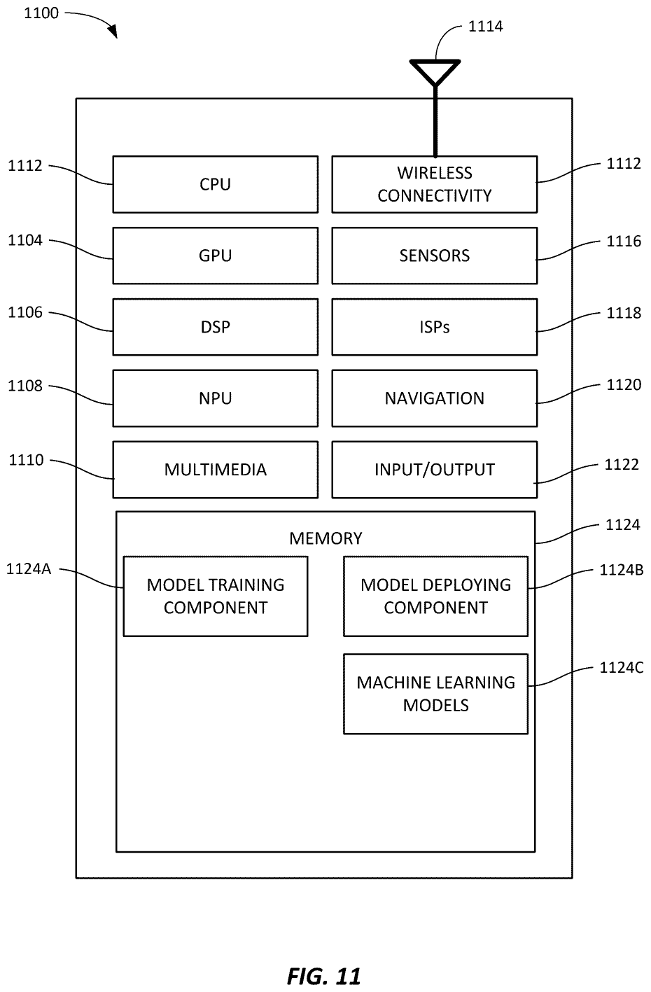

FIG. 11 depicts an example processing system 1100 for training a generative artificial intelligence model to generate a response to a query input into a generative artificial intelligence model based on self-speculative decoding and forecasted parameters, such as described herein for example with respect to FIG. 9.

The processing system 1100 includes a central processing unit (CPU) 1102, which in some examples may be a multi-core CPU. Instructions executed at the CPU 1102 may be loaded, for example, from a program memory associated with the CPU 1102 or may be loaded from a memory partition (e.g., of a memory 1124).

The processing system 1100 also includes additional processing components tailored to specific functions, such as a graphics processing unit (GPU) 1104, a digital signal processor (DSP) 1106, a neural processing unit (NPU) 1108, and a connectivity component 1112.

An NPU, such as the NPU 1108, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 1108, are configured to accelerate the performance of common machine learning tasks, such as image classification, machine translation, object detection, and various other predictive models. In some examples, a plurality of NPUs may be instantiated on a single chip, such as a system on a chip (SoC), while in other examples such NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new piece through an already trained model to generate a model output (e.g., an inference).

In some implementations, the NPU 1108 is a part of one or more of the CPU 1102, the GPU 1104, and/or the DSP 1106. These may be located on a user equipment (UE) in a wireless communication system or another computing device.

In some examples, the connectivity component 1112 may include subcomponents, for example, for third generation (3G) connectivity, fourth generation (4G) connectivity (e.g., LTE), fifth generation (5G) connectivity (e.g., NR), Wi-Fi connectivity, Bluetooth connectivity, and other wireless data transmission standards. The connectivity component 1112 may be further coupled to one or more antennas 1114.

The processing system 1100 may also include one or more sensor processing units 1116 associated with any manner of sensor, one or more image signal processors (ISPs) 1118 associated with any manner of image sensor, and/or a navigation processor 1120, which may include satellite-based positioning system components (e.g., GPS or GLONASS) as well as inertial positioning system components.

The processing system 1100 may also include one or more input and/or output devices 1122, such as screens, touch-sensitive surfaces (including touch-sensitive displays), physical buttons, speakers, microphones, and the like.

In some examples, one or more of the processors of the processing system 1100 may be based on an ARM or RISC-V instruction set.

The processing system 1100 also includes the memory 1124, which is representative of one or more static and/or dynamic memories, such as a dynamic random access memory, a flash-based static memory, and the like. In this example, the memory 1124 includes computer-executable components, which may be executed by one or more of the aforementioned processors of the processing system 1100.

In particular, in this example, the memory 1124 includes a model training component 1124A, a model deploying component 1124B, and machine learning models 1124E. The depicted components, and others not depicted, may be configured to perform various aspects of the methods described herein.

Generally, the processing system 1100 and/or components thereof may be configured to perform the methods described herein.

### Example Clauses

Implementation details of various aspects of the present disclosure are described in the following numbered clauses.

Clause 1: A processor-implemented method for machine learning, comprising: receiving an input prompt for processing; generating a set of forecasted parameters for the input prompt using a parameter prediction model; generating, using a generative artificial intelligence model, a response to the input prompt based on the input prompt and the set of forecasted parameters; and outputting the generated response.

Clause 2: The method of Clause 1, wherein generating the response to the input prompt comprises: generating a set of value tokens from data in a first modality in the input prompt; and generating a set of query tokens from data in a second modality in the input prompt, wherein the response is generated based on the set of value tokens and the set of query tokens.

Clause 3: The method of Clause 2, wherein the first modality comprises a visual data modality and wherein the second modality comprises a text data modality.

Clause 4: The method of any of Clauses 1 to 3, wherein the set of forecasted parameters comprises: one or more forecast tokens associated with a predicted input into the generative artificial intelligence model in a subsequent inferencing round, and a forecasted prefix for inclusion in a cache of the generative artificial intelligence model.

Clause 5: The method of Clause 4, wherein generating the response to the input prompt comprises masking the forecasted prefix in the cache such that the forecasted prefix is used to process the one or more forecast tokens and not used to process tokens associated with the input prompt.

Clause 6: The method of Clause 4 or 5, wherein the one or more forecast tokens comprise tokens speculatively decoded by the generative artificial intelligence model based on generation of an initial response token to the input prompt.

Clause 7: The method of any of Clauses 1 to 6, wherein a number of parameters in the set of forecasted parameters is based on a maximum draft length associated with the generative artificial intelligence model.

Clause 8: The method of any of Clauses 1 to 7, wherein the parameter prediction model comprises a truncated version of the generative artificial intelligence model.

Clause 9: The method of any of Clauses 1 to 8, wherein the generated response comprises a valid token and one or more speculatively generated draft tokens.

Clause 10: The method of any of Clauses 1 to 9, wherein: the input prompt comprises a set of tokens generated in a prior inferencing round; and the method further comprises identifying a set of verified tokens from the set of tokens generated in the prior inferencing round, wherein the set of forecasted tokens is generated based on the set of verified tokens.

Clause 11: A processing system, comprising: at least one memory having executable instructions stored thereon; and one or more processors configured to execute the executable instructions in order to cause the processing system to perform the operations of any of Clauses 1-10.

Clause 12: A processing system comprising means for performing the operations of any of Clauses 1-10.

Clause 13: A non-transitory computer-readable medium having executable instructions stored thereon which, when executed by one or more processors, perform the operations of any of Clauses 1-10.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system comprising:
one or more memories comprising processor-executable instructions; and
one or more processors coupled to the one or more memories and configured to execute the processor-executable instructions and cause the processing system to:
receive an input prompt for processing;
generate a set of forecasted parameters for the input prompt using a parameter prediction model;
generate, using a generative artificial intelligence model, a response to the input prompt based on the input prompt and the set of forecasted parameters; and
output the generated response.

2. The processing system of claim 1, wherein to generate the response to the input prompt, the one or more processors are configured to execute the processor-executable instructions and cause the processing system to:
generate a set of value tokens from data in a first modality in the input prompt; and
generate a set of query tokens from data in a second modality in the input prompt, wherein the response is generated based on the set of value tokens and the set of query tokens.

3. The processing system of claim 2, wherein the first modality comprises a visual data modality and wherein the second modality comprises a text data modality.

4. The processing system of claim 1, wherein the set of forecasted parameters comprises:
one or more forecast tokens associated with a predicted input into the generative artificial intelligence model in a subsequent inferencing round, and
a forecasted prefix for inclusion in a cache of the generative artificial intelligence model.

5. The processing system of claim 4, wherein to generate the response to the input prompt, the one or more processors are configured to execute the processor-executable instructions and cause the processing system to mask the forecasted prefix in the cache such that the forecasted prefix is used to process the one or more forecast tokens and not used to process tokens associated with the input prompt.

6. The processing system of claim 4, wherein the one or more forecast tokens comprise tokens speculatively decoded by the generative artificial intelligence model based on generation of an initial response token to the input prompt.

7. The processing system of claim 1, wherein a number of parameters in the set of forecasted parameters is based on a maximum draft length associated with the generative artificial intelligence model.

8. The processing system of claim 1, wherein the parameter prediction model comprises a truncated version of the generative artificial intelligence model.

9. The processing system of claim 1, wherein the generated response comprises a valid token and one or more speculatively generated draft tokens.

10. The processing system of claim 1, wherein:
the input prompt comprises a set of tokens generated in a prior inferencing round;
the one or more processors are configured to execute the processor-executable instructions and further cause the processing system to identify a set of verified tokens from the set of tokens generated in the prior inferencing round; and
the set of forecasted tokens is generated based on the set of verified tokens.

11. A processor-implemented method for machine learning, comprising:
receiving an input prompt for processing;
generating a set of forecasted parameters for the input prompt using a parameter prediction model;
generating, using a generative artificial intelligence model, a response to the input prompt based on the input prompt and the set of forecasted parameters; and
outputting the generated response.

12. The method of claim 11, wherein generating the response to the input prompt comprises:
generating a set of value tokens from data in a first modality in the input prompt; and
generating a set of query tokens from data in a second modality in the input prompt, wherein the response is generated based on the set of value tokens and the set of query tokens.

13. The method of claim 11, wherein the set of forecasted parameters comprises:
one or more forecast tokens associated with a predicted input into the generative artificial intelligence model in a subsequent inferencing round, and
a forecasted prefix for inclusion in a cache of the generative artificial intelligence model.

14. The method of claim 13, wherein generating the response to the input prompt comprises masking the forecasted prefix in the cache such that the forecasted prefix is used to process the one or more forecast tokens and not used to process tokens associated with the input prompt.

15. The method of claim 13, wherein the one or more forecast tokens comprise tokens speculatively decoded by the generative artificial intelligence model based on generation of an initial response token to the input prompt.

16. The method of claim 11, wherein a number of parameters in the set of forecasted parameters is based on a maximum draft length associated with the generative artificial intelligence model.

17. The method of claim 11, wherein the parameter prediction model comprises a truncated version of the generative artificial intelligence model.

18. The method of claim 11, wherein the generated response comprises a valid token and one or more speculatively generated draft tokens.

19. The method of claim 11, wherein:
the input prompt comprises a set of tokens generated in a prior inferencing round;
the method further comprises identifying a set of verified tokens from the set of tokens generated in the prior inferencing round; and
the set of forecasted tokens is generated based on the set of verified tokens.

20. A processing system comprising:
means for receiving an input prompt for processing;
means for generating a set of forecasted parameters for the input prompt using a parameter prediction model;
means for generating, using a generative artificial intelligence model, a response to the input prompt based on the input prompt and the set of forecasted parameters; and
means for outputting the generated response.
